(19) United States
(12) Patent Application Publication
(10) Pub. No.: US 2004/0109720 A1
(43) Pub. Date: Jun. 10, 2004

(54) Personal care articles

(75) Inventors: Dana Paul Gruenbacher, Fairfield, OH (US); Nicole Alisa Renee Lockett, Cincinnati, OH (US); Gary Curtis Joseph, Mason, OH (US); John David Norcom, West Chester, OH (US); Delyth Myfanwy Jenkins, Egham (GB)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH

(21) Appl. No.: 10/727,457

(22) Filed: Dec. 4, 2003

Related U.S. Application Data
(63) Continuation of application No. PCT/US02/19701, filed on Jun. 21, 2002.
(60) Provisional application No. 60/300,145, filed on Jun. 22, 2001.

(51) Int. Cl. B43K 5/14

(52) U.S. Cl. 401/133; 401/132

(57) ABSTRACT

A disposable applicator comprising a multilayered substrate containing a fluid is presented which is useful for applying fluids, particularly cosmetic lotions or creams, to an application surface, particularly a surface of a human body. The fluid is stored in a fluid storage layer and is dispensed via a flow control layer. An impermeable layer prevents the fluid from flowing back away from the application surface.

### CROSS REFERENCE TO RELATED APPLICATION(S)

This application is a continuation of International Application No. PCT/US 02/19701, filed Jun. 21, 2002, which claims the benefit of U.S. Provisional Application No. 60/300,145, filed Jun. 22, 2001.

### TECHNICAL FIELD

The present invention relates to disposable, fluid applicators useful for applying a fluid such as a lotion to the skin or other sites. These applicators comprise multiple layers and fluid. Consumers use the applicators by wiping them on the area where they wish to apply the fluid. The invention also encompasses a method for applying fluid to the skin using the applicators of the present invention.

### BACKGROUND OF THE INVENTION

Applying a fluid such as body lotion to the skin is usually a messy experience. Most body lotions are sold in large bottles. The user pours a quantity of the lotion into their hands and applies it to their skin or the skin of another. Typically, this leaves the user with an uncomfortable amount of lotion residue on their hands and wastes material. As a result, many people don't use body lotion or use it infrequently.

Several devices have been suggested for applying fluids to the skin. Generally, these devices have a fluid-containing layer and some kind of facing material. References disclosing fluid applicators include U.S. Pat. No. 6,156,323; U.S. Pat. No. 4,762,124; U.S. Pat. No. 4,515,703 and EP-A-0 112 654. However, a need still exists for a disposable applicator that can apply a controlled amount of fluid while providing a comfortable experience for the user.

### SUMMARY OF THE INVENTION

According to a first aspect of the invention, a disposable fluid applicator is presented, the applicator comprising a substrate and a fluid, said substrate comprising, in succession:

a) A flow control layer;

b) A fluid storage layer; and

c) A fluid impermeable layer wherein at least about 0.5 milliliters of said fluid are present in said fluid storage layer.

The disposable applicator according to the invention already comprises the fluid to be dispensed, so does not require addition of any fluid prior to use.

Advantageously, from about 10 milliliters to about 20 milliliters of said fluid are present in said fluid storage layer. More advantageously, the fluid strorage layer comprises from about 12 milliliters to about 15 milliliters of the fluid.

The present fluids comprises an active agent, which may be selected from the group comprising vitamin compounds, skin treating agents, cleansing surfactants, anti-acne actives, anti-wrinkle actives, anti-skin atrophy actives, anti-inflammatory actives, topical anesthetics, coloring agents, artificial tanning actives and accelerators, anti-microbial actives, anti-fungal actives, anti-viral agents, enzymes, sunscreen actives, anti-oxidants, skin exfoliating agents, and combinations thereof.

The flow control layer according to the invention may comprise an apertured film, non-woven material, non-woven with mocrofibers, woven material, meltblown structure or mixtures of these materials. Advantageously, the flow control layer comprises CLIFF™ (Cloth Like Formed Film) hydroapertured film of LDPE with 1% Atmer and 0.8 gsm silicone coating (Tredegar Corp.).

The fluid storage layer according to the invention may comprise batting, sponge or foam. Advantageously, it the batting may itself comprise viscose fibers. Additionally or alternatively, the fluid storage layer may comprise a dosing reservoir capable of containing and dispensing fluid. Advantageously, the dosing reservoir is rupturable, although other methods known to the skilled person may be used to facilitate release of the fluid.

The fluid impermeable layer according to the invention may comprise a polymer film, a metal foil or a mixture or laminate of these materials.

Advantageously, the disposable applicator according to the invention may comprise a skin contact layer located on the opposite side of the flow control layer to the fluid storage layer and/or a hand contact layer located on the opposite side of the fluid impermeable layer to the fluid storage layer. The hand contact layer and the skin contact layer may comprise identical or different materials selected from woven materials, non-woven materials, natural or synethic sponge, polymeric mesh sponge, paper substrate, polymeric porous foam, collagen sheets, polymeric scrim and mixtures of these materials.

Advantageously, the disposable applicator according to the present invention may additionally comprise a temperature-change element for heating or cooling the substrate, the fluid or both. The temperature-change element may provide heat derived from a chemical reaction, heat of solution, crystallisation, an electrical heating element or a mixture of these Alternatively, the temperature-change element may be a cooling element and cooling may be provided by an endothermic chemical reaction, an electrical cooling element or a mixture of these. According to a specific embodiment, the disposable applicator may additionally define a catalyst chamber containing a catalyst and a separate reactant chamber containing a reactant the chambers being rupturable so that on rupture their respective contents mix to initiate the reaction and generate the temperature change.

According to a second aspect of the invention, a method of applying a fluid to skin is presented comprising the steps of holding the disposable applicator according to any one of the preceding claims and wiping it onto the skin.

### BRIEF DESCRIPTION OF THE DRAWINGS

While the specification concludes with claims which particularly point out and distinctly claim the invention, it is believed the present invention will be better understood from the following description of preferred embodiments taken in conjunction with the accompanying drawings, in which like reference numerals identify identical elements and in which:

FIGS. 1 and 2 illustrate embodiments of the present invention comprising a temperature-change element as defined hereinbelow, which provides heating or cooling to the disposable fluid applicator.

### DETAILED DESCRIPTION OF THE INVENTION

All percentages and ratios used herein are by weight of the total composition and all measurements made are at 25° C., unless otherwise designated.

All publications cited herein are hereby incorporated by reference in their entirety.

Except where specific examples of actual measured values are presented, numerical values referred to herein should be considered to be qualified by the word “about”.

s used herein, “disposable” is used in its ordinary sense to mean an applicator that is disposed or discarded after a limited number of usage events, preferably less than 25, more preferably less than about 10, and most preferably less than about 2 entire usage events.

As used herein, the term “microfibers” includes fibers having an average diameter not greater than about 100 microns, preferably having a diameter of about 0.5 microns to about 50 microns, more preferably having an average diameter of from about 1 micron to about 20 microns. Microfibers having an average diameter of about 3 microns or less are sometimes referred to as ultra-fine microfibers.

As used herein, the term “fluid” includes flowable materials such as liquids, gels, lotions, creams and powders. The term may even include materials which are solid at room temperature, such as certain waxes, but which may be heated in use to liquefy them.

Active and other ingredients useful herein may be categorized or described herein by their cosmetic and/or therapeutic benefit or their postulated mode of action. However, it is to be understood that the active and other ingredients useful herein can in some instances provide more than one cosmetic and/or therapeutic benefit or operate via more than one mode of action. Therefore, classifications herein are made for the sake of convenience and are not intended to limit an ingredient to the particularly stated application or applications listed.

The present invention defines an applicator system to deposit fluid onto a target surface. In a preferred embodiment, it is a single use applicator to deposit a cosmetic fluid, such as body lotion onto part of the human body, such as human skin or hair. The applicator system has several advantages in the areas of product efficacy and in-use experience for the user. The applicator is quick and easy to use. The applicator protects the user's hands from contact with the product. This has advantages for reduced messiness and can protect the user's skin from irritants (e.g. pigmented products, self-tanners, dyes, bleaches) in the case where it is being applied by another person. The applicator also has hygiene benefits because it eliminates hand-to-skin contact during the application process (e.g. for the treatment of diaper rash or athlete's foot).

The applicator allows delivery of incompatible ingredients from a single device. For example, it can deliver ingredients with different pH requirements (e.g. salicylic acid/niacinamide) or materials with poor water stability (e.g. enzyme+moisturizer combinations). The applicator substrate may deliver efficacy benefits via exfoliation of the skin. This has the effect of smoothing the skin's surface and may also enhance ingredient penetration into the skin. The surface texture of the applicator substrate may also provide the user with a massage sensation during use. The applicator may also be designed to deliver warmth or cooling during the application process. This enhances the user's experience and a warming effect may also increase ingredient penetration. In addition, the shape and size of the applicator can be varied and additional features added to customize the ergonomics (e.g. addition of handle/strap, high friction coating to improve grip, form as a glove or mitt).

The skin contact layer of the present invention may comprise materials that provide appropriate skin feel characteristics but are sufficiently robust to retain their integrity during repeated rubbing over the skin. Appropriate skin feel characteristics may include, for example, a pleasant, invigorating and/or massaging feel. Achieving the relevant skin feel characteristics may be accomplished by using multiple materials to provide areas with different feels. For example, the skin contact layer may have areas that provide a pleasant (soft) skin sensation and other areas that provide a rougher invigorating sensation. The skin contact layer may be formed from any substrate that can provide appropriate in-use feel but be sufficiently robust to maintain integrity after repeated rubbing over the skin. The skin contact layer may also provide additional flow control for the fluid.

Non-limiting examples of suitable substrates meeting the above criteria include woven and nonwoven materials; natural sponges; synthetic sponges; polymeric mesh sponge; paper substrates; polymeric porous foams; collagen sheets; polymeric scrims and the like. Preferred substrates for use herein are paper substrates and nonwoven materials since they are economical and readily available to fit most technical specifications.

The nonwoven materials may comprise a combination of layers of random and carded fibers. The fibers may be of natural or synthetic origin. Natural fibers useful in the present invention are silk fibers, keratin fibers such as wool fibers, camel hair fibers, and the like and cellulosic fibers including wood pulp fibers, cotton fibers, hemp fibers, jute fibers, flax fibers, and mixtures thereof. Synthetic fibers useful in the present invention include acetate fibers, acrylic fibers, cellulose ester fibers, modacrylic fibers, polyamide fibers, polyester fibers, polyolefin fibers, polyvinyl alcohol fibers, rayon fibers, polyurethane foam, and mixtures thereof.

The nonwoven layer may be prepared by a variety of processes including hydroentanglement, air entanglement, thermally bonding or thermo-bonding, and combinations of these processes. Moreover, the substrates of the present invention can consist of a single layer or multiple layers. In addition, a multilayered substrate can include films and other nonfibrous materials.

Nonwoven materials made from synthetic fibers may be obtained from a wide variety of commercial sources. Examples of suitable nonwoven layer materials useful herein are described in WO98/18444 and include HEF 40-047, an apertured hydroentangled material containing about 50% rayon and 50% polyester, and having a basis weight of about 51 grams per square metre (gsm), available from Veratec, Inc., Walpole, Mass.; Novonet® 149-616, a thermo-bonded grid patterned material containing about 100% polypropylene, and having a basis weight of about 60 gsm, available from Veratec, Inc., Walpole, Mass.; and HEF Nubtex™ 149-801, a nubbed, apertured hydroentangled material, containing about 100% polyester, and having a basis weight of about 84 gsm, available from Veratec, Inc. Walpole, Mass.

The multi-layered non-wovens which may be employed according to the invention may be apertured laminated webs. These can be made by methods known in the art. One advantageous method of aperturing a nonwoven web, for example, is disclosed in commonly-assigned U.S. Pat. No. 5,916,661. This patent teaches a laminate material having, for example, at least one layer of a spunbonded web joined to at least one layer of a meltblown web, a bonded carded web, or other suitable material. This material shall be referred to for the purpose of this patent as SAN (Stretch Apertured Nonwoven). Also suitable for use in this application is the laminate web described in U.S. Ser. No. 09/46793, which teaches a Differential Elongation Composite (DEC). This material is a a laminate web having a plurality of apertures, said laminate web comprising:

1) a first extensible web having a first elongation to break;

2) a second extensible web joined to said first extensible web at a plurality of bond sites, said second extensible web having a second elongation to break; and

3) a third web material being disposed between said first and second webs, said third web material having a third elongation to break which is less than both of said first or second elongations to break.

In another embodiment, an apertured laminate web may be employed having first and second extensible webs being joined at a plurality of discrete bond sites and a third material disposed between the first and second nonwoven webs. The first and second nonwoven webs are in fluid communication via the apertures and have distinct regions being differentiated by at least one property selected from the group consisting of basis weight, fiber orientation, thickness, and density.

The material described above is referred to as DEC and is supplied by the Procter & Gamble Company.

Paper substrates made from natural materials consist of webs or sheets most commonly formed on a fine wire screen from a liquid suspension of the fibers. See C. A. Hampel et al., The Encyclopedia of Chemistry, third edition, 1973, pp. 793-795 (1973); The Encyclopedia Americana, vol. 21, pp. 376-383 (1984); and G. A. Smook, Handbook of Pulp and Paper Technologies, Technical Association for the Pulp and Paper Industry (1986). Paper substrates made from natural materials useful in the present invention can be obtained from a wide variety of commercial sources. Suitable commercially available paper substrates useful herein include “Kimwipes EX-L” available from Kimberley-Clark Corp., Roswell, Ga., USA; Airtex®, an embossed airlaid cellulosic layer having a base weight of about 85 gsm, available from James River, Green Bay, Wis.; and Walkisoft®, an embossed airlaid cellulosic having a base weight of about 90 gsm, available from Walkisoft U.S.A., Mount Holly, N.C.

Polymeric mesh sponges which may be incorporated into fluid applicators according to the invention include those described in EP-A-702550 and WO98/18444.

Polymeric porous foams which may be incorporated into fluid applicators according to the invention include those described in U.S. Pat. No. 5,260,345 and U.S. Pat. No. 4,394,930.

Preferably, the skin contact layer is selected from Novonet 149-616, Corovin LLDPE, SAN, PP/Rayon mixtures supplied by Suominen and DEC. Even more preferably the skin contact layer comprises Corovin LLDPE, PP/Rayon mixtures from Suominen and DEC. More preferably, the skin contact layer comprises Corovin LLDPE 60 gsm, spunbonded.

The flow control layer is a permeable substrate layer (or layers) that controls transfer of the fluid from the fluid storage layer to the skin. Non-limiting examples include apertured films, non-wovens, non-wovens with microfibers, wovens, meltblown structures, and combinations thereof, or other flexible materials known to those skilled in the art to control fluid flow. Non-woven membranes made with microfibers can allow for thinner substrates since smaller effective pores can be created.

In order to achieve flow control according to the invention, the flow control layer will advantageously have a water flux rate, measured according to the Water Flux Rate Test as defined hereinbelow, in the range 5-500 cm³/cm²-s, preferably in the range 10-100 cm³/cm²-s and more preferably in the range 15-60 cm³/cm²-s.

The aperture size of the apertured film may be between 20 microns to 500 microns, more preferably 50 microns to 200 microns. The number of holes can be adjusted to change the net flow rate as required, but is preferably in the range 100-2000 apertures/cm² and more preferably in the range 500-1700 apertures/cm².

In the case of non-wovens, wovens, and meltblown structures the porosity may be controlled by the basis weight (thickness) of the structure as well as the mean fiber diameter; the number and size of the fibers essentially creates pores where fluid can occupy space and change flow rate for a given pressure. Suitable meltblowns have been shown to have a basis weight range from 2 gsm to 30 gsm, thus, basis weight can be used to adjust porosity and thus flow rate.

A formed-film substrate useful herein is an apertured formed film—a resilient, 3-dimensional web exhibiting a fiber-like appearance and tactile impression, comprising a fluid-impervious plastic material, with said web having a multiplicity of apertures, the apertures being defined by a multiplicity of intersecting fiberlike elements, as described in U.S. Pat. No. 4,342,314. The sheet materials described in U.S. Pat. No. 4,342,314 can be prepared using hydrophobic plastics such as polyethylene, polypropylene, PVC, and the like, and are well-known for use in absorbent products such as catamenials. An example of such a material is the formed film described in the above patent and marketed on sanitary napkins by The Procter and Gamble Company as “DRI-WEAVE”. Additionally, such materials may be surface treated to reduce their hydrophobicity. An additional example of a formed-film substrate suitable for use in this application is CLIFF (Cloth Like Formed Film) Hydroapertured formed film, LDPE with 1% ATMER™ (Uniquema) and 0.8 gsm Si coating

Preferably, the flow control layer is selected from DRI-WEAVE and CLIFF hydroapertured formed film, LDPE with 1% Atmer 100 and 0.8 gsm Si coating. Most preferably the flow control layer is selected from CLIFF hydroapertured formed film, LDPE with 1% Atmer 100 and 0.8 gsm Si coating

The fluid storage layer of the present invention is used to store and to help control release of the fluid. This layer may comprise one or more materials having absorbent properties and/or comprising voids for storage of fluid. Non-limiting examples of absorbent material-types include batting (a form of non-woven material), sponges and foams. Suitable sponge materials are polymeric mesh sponges as disclosed in EP 0 702 550 and WO 98/18444.

Batting useful in the fluid storage layer of the present invention is preferably lofty. As used herein, “lofty” means that the layer has density of from about 0.00005 g/cm³ to about 0.1 g/cm³, preferably from about 0.001 g/cm³ to about 0.09 g/cm³ and a thickness of from about 0.1 cm (0.04 inches) to about 5 cm (2 inches) at 5 gms/in².

The batting may comprise synthetic or natural materials, but preferably comprises synthetic materials, such as acetate fibers, acrylic fibers, cellulose ester fibers, modacrylic fibers, polyamide fibers, polyester fibers, polyolefin fibers, polyvinyl alcohol fibers, rayon fibers, polyethylene foam, polyurethane foam, and combinations thereof. Preferred synthetic materials, particularly fibers, may be selected from the group consisting of nylon fibers, rayon fibers, polyolefin fibers, polyester fibers, and combinations thereof. Preferred polyolefin fibers are fibers selected from the group consisting of polyethylene, polypropylene, polybutylene, polypentene, and combinations and copolymers thereof. More preferred polyolefin fibers are fibers selected from the group consisting of polyethylene, polypropylene, and combinations and copolymers thereof. Preferred polyester fibers are fibers selected from the group consisting of polyethylene terephthalate, polybutylene terephthalate, polycyclohexylenedimethylene terephthalate, and combinations and copolymers thereof. More preferred polyester fibers are fibers selected from the group consisting of polyethylene terephthalate, polybutylene terephthalate, and combinations and copolymers thereof. Most preferred synthetic fibers comprise solid staple polyester fibers that comprise polyethylene terephthalate homopolymers.

Suitable synthetic materials may include solid single component (i.e., chemically homogeneous) fibers, multiconstituent fibers (i.e., more than one type of material making up each fiber), and multicomponent fibers (i.e., synthetic fibers which comprise two or more distinct filament types which are somehow intertwined to produce a larger fiber), and combinations thereof. Preferred fibers include bicomponent fibers, multiconstituent fibers, and combinations thereof. Such bicomponent fibers may have a core-sheath configuration or a side-by-side configuration. In either instance, the batting layer may comprise either a combination of fibers comprising the above-listed materials or fibers which themselves comprise a combination of the above-listed materials.

For the core-sheath fibers, preferably, the cores comprise materials selected from the group consisting of polyesters, polyolefins having a T_{g} of at least about 10° C. higher than the sheath material, and combinations thereof. Conversely, the sheaths of the bicomponent fibers preferably comprise materials selected from the group consisting of polyolefins having a T_{g} of at least about 10° C. lower than the core material, polyesters polyolefins having a T_{g} of at least about 10° C. lower than the core material, and combinations thereof.

In all cases—side-by-side configuration, core-sheath configuration and solid single component configuration, the fibers of the batting layer may exhibit a helical, spiral or crimped configuration, particularly the bicomponent type fibers.

Furthermore, the batting fibers preferably have an average thickness of from about 0.5 microns to about 150 microns. More preferably, the average thickness of the fibers are from about 5 microns to about 75 microns. In an even more preferred embodiment, the average thickness of the fibers are from about 8 microns to about 40 microns. Furthermore, the batting fibers may be of varying sizes, i.e., the fibers of the batting layer may comprise fibers having different average thicknesses. Also, the cross section of the fibers can be round, flat, oval, elliptical or otherwise shaped.

In another embodiment, the batting may comprise a composite material, i.e., a material having one or more plies of the same or different suitable materials merely superimposed physically, joined together continuously (e.g., laminated, etc.) or in a discontinuous pattern, or by bonding at the external edges (or periphery) of the layer and/or at discrete loci. For instance, the batting may further comprise composite materials selected from the group consisting of fibrous nonwovens, sponges, foams, reticulated foams, polymeric nets, scrims, vacuum-formed laminates, formed films and formed film composite materials. A preferred batting comprises a formed film composite material comprising at least one formed film and at least one nonwoven wherein the layer is vacuum formed. A suitable formed film composite material includes, but is not limited to, a vacuum laminated composite formed film material formed by combining a carded polypropylene nonwoven having a basis weight of 30 gsm with a formed film.

Advantageously, the batting in the present fluid storage layers comprises viscose, preferably at least 50% wt viscose, more preferably at least 80% viscose and even more preferably at least 90% viscose. In one embodiment, the fluid storage layer may be 100% 200 gsm needle punched viscose. Viscose has the advantage that, following use, less of the fluid is irretrievably retained within the applicator than may occur with other materials, thereby reducing fluid wastage.

In addition or alternatively, the fluid storage layer may comprise product wells, as described in WO 98/55109 and WO 97/25268.

Additionally or alternatively, the fluid storage layer of the present invention may comprise a dosing reservoir with a frangible seal. Such a dosing reservoir contains fluid that may be dispensed and/or dispersed from at least one internal chamber within the dosing reservoir to one or more outer surfaces of the reservoir, for delivery to a target surface. The one or more internal chambers may be of any suitable size, configuration, and composition for the fluid to be dispensed and dispersed. In the event that the disposable fluid applicator has a wipe-like configuration, for example, the one or more chambers may have a substantially planar configuration.

One important aspect of the dosing reservoir, is its ability to rupture or otherwise dispense a contained fluid when “activated” by the user, and yet, resist premature dispensing during manufacture, packaging, and shipment, thereby preserving the quality and quantity fluid until the time of use. The dosing reservoir may be made from a flexible film sealed around the perimeter by permeable membrane. In a non-limiting example, the dosing reservoir can be formed from a single material partially or completely folded onto itself. The folded material may then be heat sealed on at least three sides. The interior volume or volumes can then contain the fluid. The dosing reservoir may also be made by sealing two films to each other along a common perimeter. The flexible film can include a sealant on one or both sides and can include a higher melting support structure such as a thin layer of PET, nylon, or polypropylene. Seals that create the dosing reservoir can be both permanent seals, such as such as lock-up or welded seals, or have a rupturable or frangible capacity.

In one embodiment, the dosing reservoir can be designed to burst or rupture to release fluid at a comparatively low force, e.g., finger or hand pressure, when desired. This may be accomplished by having a sealing system with permanent seals and a frangible seal. As used herein, the term “frangible” means rupturable and results in a release of fluid. Permanent seals are those that do not rupture when force is applied to the dosing reservoir or the cell. When the reservoir is squeezed, the frangible seal yields or fails first since it has a lower peel force to break the seal apart than the other seals. In one embodiment, the frangible seal will ideally rupture with 2.23-44.5N (0.5-10 pounds), more preferably 4.45-17.8N (1-4 pounds) of applied force.

Advantageously, a stress concentrator may be incorporated in the seal geometry of the frangible seal to localize forces, providing a suitable and predictable rupture location. Stress concentrators can be shaped like a ‘V’, a notch, a half circle or a variety of other shapes depending upon the desired burst strength and characteristics. Stress concentrators can help control the force required to burst the cell as well as the location of where the frangible seal ruptures. For example, a pressurizing reservoir having a V-notch seal can localize forces mainly at the apex of the V, causing that region to rupture first. This can help reduce variability in rupture or dispensing forces and the location where the rupture occurs.

The interior volume of the reservoir may be comprised of multiple chambers for mixing incompatible products. As a non-limiting example, the fluid in one chamber may be a skin cleansing solution, while the fluid in another chamber may be a skin moisturizing oil. Alternatively, several formulations may be dosed sequentially to deliver superior performance.

The dosing reservoir may be defined by a flexible film. Flexible films which may be used include those having a permeation of less than 10% product loss/year at 35° C./20% RH, so that the active compound maintains its designed activity. This can be achieved by using a film which is: liquid impervious in that no liquid passes through it after 30 sec.; a barrier to vapors/solvents in that its water vapor transmission rate (WVTR) is less than 6 g/sqm/day at 40° C./90% RH; and optionally a barrier to gases, in that its O₂TR (oxygen transmission rate) is less than 200 cc/sqm/day/atm at 23° C./50% RH.

Preferably the film is a laminate film or other multi-layer structure that comprises a high barrier material, such as metallized PET, aluminum foil, SiO₂ or a mixture of these. In a preferred embodiment, the film comprises a laminate itself comprising at least one aluminum layer that gives very good barrier properties to liquids, gas and vapors, for example, a Surlyn®/metallized PET/LDPE having thicknesses of 50 μm/12 μm/24 μm respectively. Optionally, thermoplastics, such as high-density polyethylene (HDPE) more than 50 μm thick, or polypropylene (PP) more than 100 μm thick, or low-density polyethylene (LDPE) more than 150 μm thick can be used. Even if such materials are not inherently high barrier materials, the thickness used allows good barrier properties.

Preferably the fluid storage layer is selected from polyester/polyethylene terephthalate batting with a basis weight of 80 gsm supplied by Sandier, Schwarzenbach, Germany or viscose with a basis weight of 200 gsm. Most preferably the fluid storage layer comprises 200 gsm, 100% needle-punched viscose.

The fluid impermeable layer of the present invention is used to prevent backwards flow of the fluid onto the user's hand, thereby wasting it and potentially causing discomfort and irritation to the user, especially where they are not the person to whom the fluid is being applied. Any flexible fluid impermeable material may be used. Preferred materials include polymer films, foil or foil laminates, and breathable substrates (water proof but allows gas/vapor transmission) such as GORETEX™. Preferably, the fluid impermeable material of the present invention is a polyolefin film. More preferably, it is polypropylene or polyethylene, preferably polyethylene. Still more preferably, the material is low density polyethylene (LDPE). In a preferred embodiment, the fluid impermeable layer is LDPE formed film.

The hand contact layer of the present invention is intended to improve the feel and handling of the applicator. Preferably, it is a material that is soft and more pleasant to touch than typical formed film. Suitable materials include woven and nonwoven materials; natural or synthetic sponges; polymeric mesh sponge; paper substrates; polymeric porous foams; collagen sheets; polymeric scrims and the like. Preferred materials for use herein are paper substrates and nonwoven materials since they are economical and readily available in a variety of materials. These materials are described in more detail above in the discussion of the skin contact layer. Preferably, the hand contact layer is made from a synthetic non-woven material. More preferably, it is made from Fibrella 3100 62, 50:50 rayon:polypropylene, hydroentangled.

The hand contact layer may additionally or alternatively comprise a tacky or friction-enhancing material to ease handling of the applicator. Suitable materials that can be used as the friction-enhancing elements include rubber, thermoplastic elastomers (e.g., KRATON® produced by Shell Chemical Company), polyolefins with ethylene vinyl acetate or alpha-olefin copolymers, and polyolefin plastomers (e.g., Affinity® produced by Dow Chemical of Midland, Mich. and Exact® polyolefin plastomers produced by Exxon Chemical of Houston, Tex.).

The tacky material can cover the entire surface of the hand contact layer or be located in discrete spots. In one embodiment, for example, a hot melt coating produced by Ato Findlay of Wauwatosa, Wis. under the designation of product 195-338, can be slot coated onto the hand contact layer. The coating can also be applied in a foamed state such as by the addition of physical blowing agents such as nitrogen and/or carbon dioxide. In addition to slot coating, suitable materials can be applied (foamed or unfoamed) in one or more of an array of lines, spirals, spots and/or any other patterned network, by spraying, gravure printing, or by adhesively or otherwise securing separate pre-formed elements.

The layers comprised within the present substrate may be connected to one another in a number of ways known to the person skilled in this art, such as by means of adhesive or by ultrasonic bonding. Bonding may be at the perimeter seal only and/or at other locations. Preferably the substrate also comprises small seal spots (about 1 mm in diameter, about 1 cm spacing) between the substrate layers to help prevent layer sliding as the applicator is wiped over the skin's surface.

The disposable fluid applicator according to the invention may also include one or more temperature change elements, being heating/cooling elements, such as those described in WO 01/26528 or other heating/cooling elements known in the art. A suitable liquid-liquid heating element is disclosed in WO 02/30251 and WO 02/30237. The heating/cooling element may be used to heat a substrate of the applicator such as the skin contact layer and/or the hand contact layer, or may be used to heat a product in the fluid storage layer and/or on or in another portion of the applicator such as the flow control layer. In some cases, the heat provided to product in the fluid storage layer may melt it to render it flowable in the first place. The liberation of heat may take the form of a chemical reaction, heat of solution, oxidation or crystallization, although not limited to these types of reactions. Examples of cooling elements suitable for use in this application include, but are not limited to ammonium bichromate, calcium nitrate, ammonium nitrate coupled with a suitable catalyst such as water and the combination results in a endothermic system.

The temperature-change element may be defined by one layer of folded film or two layers of film sealed about its perimeter and containing at least two chambers separated by a frangible seal. With the application of pressure said frangible seal disengages and allows for the mixing of the catalyst and reactant, resulting in an exothermic or endothermic effect. Further, the temperature-change element may consist of a closed and flexible container covered by a removable layer. The removing action resulting in the addition of oxygen to a reactant such as a mixture of iron, sodium chloride and vermiculite, resulting in an endothermic reaction. Further, the temperature-change element may consist of a supersaturated salt with a consumer-activated disruptive element (i.e. scratchable metal, breaking class, release of a seed crystal) which results in the crystallization of said solution at an elevated temperature. In a preferred element, this salt may be sodium acetate mixed with water in a 1:1 ratio with a small glass disc present in the solution. Upon breaking this disc, the system equilibrium compromised via the addition of a nucleation site and subsequent crystallization at a temperature of approximately 54° C.

The temperature-change element may be co-joined to the product-containing element via adhesive, tape or the like. The temperature-change element may also be formed in an integral fashion with the product-containing chamber to remove any gaps or voids which would hinder optimal conductive heat transfer. The temperature-change element may also be fully or partially submersed in the product resulting in a greater utilization of all temperature-changing surfaces per unit length.

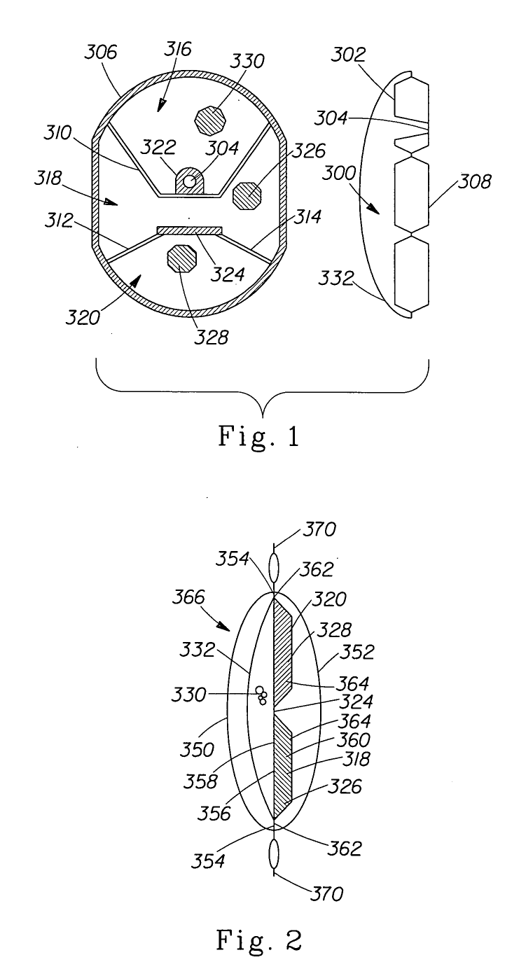

With reference to FIG. 1, an embodiment of the present invention is illustrated comprising a temperature-change element. In this embodiment, the applicator (306) consists of four layers of material: the top layer is the flow control layer (332) which comprises a membrane through which product is transferred from the applicator to the skin. Flow control layer (332) is permanently sealed around the perimeter of the applicator to fluid impermeable layer (308).

A further layer (302) (also an impermeable film) is sealed on both sides. This layer has a hole, (304) of about 5 mm diameter punched it.

The impermeable layer (308) and the further layer (302) are permanently sealed around the perimeter of the applicator. Three additional permanent seals are made in areas (310), (312) and (314). These seals, in conjunction with the perimeter seal, divide the area defined as between the fluid impermeable and further layers and interior to the perimeter seal, into three zones. These zones are identified as (316), (318), and (320). In the current embodiment, zone (320) is a chamber containing a catalyst, zone (318) is a chamber containing a reactant, and zone (316) is a chamber containing fluid (330) (the fluid storage layer). The interior permanent seals are angled to create stress concentrators that aid in the activation of the frangible seals (322) and (324).

When the catalyst chamber, (320), is compressed, the resulting increase in internal pressure stresses the frangible seal, (324), between the two layers. Since the frangible seal has the weakest peel strength, and the fact that the pressure in the frangible seal area is greater due to the angled stress concentrators, the frangible seal (324) ruptures allowing the catalyst, (328), and reactant, (326), to mix. This reaction generates a change in temperature. When the product chamber (316) is compressed, the frangible seal (322) is ruptured allowing the heated lotion to pass through hole 304 and chamber 300 and then out through the flow control layer (332).

With reference to FIG. 2, a further embodiment of the present invention is illustrated comprising a temperature-change element (364). This embodiment comprises a skin contact layer (350) adjacent to a flow control layer (332), which comprises a membrane. The skin contact layer (350) and the flow control layer can also be integrally formed. Fluid control layer (332) is permanently sealed around the perimeter to further layer (356). Further layer (356) is a film having multiple polymer layers; it is important that there is sealable polymer content on both surfaces of the film to allow for thermal bonding of said film and that it be impermeable. The void space created between the flow control membrane (332) and further layer (356) is the fluid storage layer (330). Fluid impermeable layer (352) is permanently sealed around the perimeter (362) of the temperature-changing element (364) to further layer (356). The fluid impermeable layer (352) is also sealable on both surfaces.

The temperature-change element (364) comprises a catalyst chamber (320) and a reactant chamber (318). These chambers are created by a frangible seal (324) which bisects the area between the opposing surfaces (356, 360) of the temperature-change element.

When the catalyst chamber (320) is compressed, the resulting increase in internal pressure stresses the seals between the two layers (356,360). As the frangible seal (324) is the weakest link, said frangible seal ruptures, allowing the catalyst (328) and reactant (326) to mix. This reaction generates a change in temperature.

The entire construction may have a hand containment strap or hood added to create a finger mitt embodiment.

The disposable applicator according to the invention comprises at least 0.5 ml of fluid, preferably from 10 to 20 ml of fluid and more preferably from about 12 to about 15 ml of fluid.

The fluid according to the present invention may comprise one or more cosmetic and/or pharmaceutical active agent. Non-limiting examples of active agents are vitamin compounds, skin treating agents, cleansing surfactants, anti-acne actives, anti-wrinkle actives, anti-skin atrophy actives, anti-inflammatory actives, topical anesthetics, coloring agents, artificial tanning actives and accelerators, anti-microbial actives, anti-fungal actives, anti-viral agents, enzymes, sunscreen actives, anti-oxidants, and/or skin exfoliating agents. The fluid generally also comprises a cosmetically and/or pharmaceutically acceptable vehicle which acts as a diluent, dispersant, solvent, or the like for the active and any particulates present thereby ensuring that it is applied to and distributed evenly over the selected target at an appropriate concentration.

Preferably, the fluid is a lotion comprising skin treating agents, and/or coloring agents.

The rheology of the fluid formulation can be modified over a wide range, from thin lotions, through gels/creams to waxy solids like lipsticks. The formulation type can also be varied (e.g. gels, oil-in-water (o/w) emulsions, water-in-silicone (w/Si) emulsions.

Vitamins which may be included in the fluid include retinoids, vitamin B₃ compounds, vitamin C compounds, vitamin E compounds, and mixtures thereof.

As used herein, “vitamin B₃ compound” means a compound having the formula:

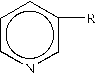

wherein R is —CONH₂ (i.e., niacinamide), —COOH (i.e., nicotinic acid) or —CH₂OH (i.e., nicotinyl alcohol); derivatives thereof; and salts of any of the foregoing.

Exemplary derivatives of the foregoing vitamin B₃ compounds include nicotinic acid esters, including non-vasodilating esters of nicotinic acid, nicotinyl amino acids, nicotinyl alcohol esters of carboxylic acids, nicotinic acid N-oxide and niacinamide N-oxide. As used herein, “non-vasodilating” means that the ester does not commonly yield a visible flushing response after application to the skin in the subject compositions (the majority of the general population would not experience a visible flushing response, although such compounds may cause vasodilation not visible to the naked eye, i.e., the ester is non-rubefacient). Non-vasodilating esters of nicotinic acid include tocopherol nicotinate and inositol hexanicotinate; tocopherol nicotinate is preferred.

Preferred vitamin B₃ compounds are niacinamide and tocopherol nicotinate. Niacinamide is more preferred.

As used herein, the term vitamin C compounds includes ascorbic acid and ist salts, ascorbyl esters of fatty acids, and ascorbic acid derivatives such as magnesium ascorbyl phosphate. Reference is made to the discussion of anti-oxidants/radical scavengers hereinbelow.

As used herein, “retinoid” includes all natural and/or synthetic analogues of Vitamin A or retinol-like compounds which possess the biological activity of Vitamin A in the skin as well as the geometric isomers and stereoisomers of these compounds. The retinoid is preferably retinol, retinol esters (e.g., C₂-C₂₂ alkyl esters of retinol, including retinyl palmitate, retinyl acetate, retinyl propionate), retinal, and/or retinoic acid (including all-trans retinoic acid and/or 13-cis-retinoic acid) or its esters such as tocopheryl retinoate. Preferably retinoids other than retinoic acid are used.

As used herein, the term vitamin E compounds includes tocopherol and esters thereof. Reference is made to the discussion of anti-oxidants/radical scavengers hereinbelow.

The present fluids may also comprise anti-inflammatory agents. These enhance the skin appearance benefits of the present invention, e.g., such agents contribute to a more uniform and acceptable skin tone or color. The exact amount of anti-inflammatory agent to be used in the compositions will depend on the particular anti-inflammatory agent utilized since such agents vary widely in potency.

Anti-inflammatory agents useful herein include steroids such as hydrocortisone; non-steroidal anti-inflammatory drugs (NSAIDS) such as ibuprofen; panthenol and ether and ester derivatives thereof e.g. panthenol ethyl ether, panthenyl triacetate; pantothenic acid and salt and ester derivatives thereof, especially calcium pantothenate; aloe vera, bisabolol, allantoin and compounds of the liquorice (the plant genus/species Glycyrrhiza glabra) family, including glycyrrhetic acid, glycyrrhizic acid, and derivatives thereof e.g. salts such as ammonium glycyrrhizinate and esters such as stearyl glycyrrhetinate. Particularly preferred herein are panthenol, pantothenic acid and their ether, ester or salt derivatives and mixtures thereof; suitable levels are from about 0.1 to about 5%, preferably from about 0.5 to about 3%. Panthenol is especially preferred. Panthenol additionally provides short-term benefits such as humectancy.

Suitable sunscreens which may be included in the fluid may be organic or inorganic. Especially preferred organic sunscreens include butylmethoxydibenzoylmethane, 2-ethylhexyl-p-methoxycinnamate, phenyl benzimidazole sulfonic acid, and octocrylene. Inorganic sunscreens include zinc oxide and titanium dioxide.

The present fluids may comprise slimming agents as well as actives useful in providing cellulite control. Among these agents are phosphodiesterase inhibitors (e.g., xanthine derivatives such as theophylline, caffeine, theobromine or salts thereof such as aminophylline) and certain oleosoluble vegetable extracts, including, principally, those of climbing ivy (Hedera Helix), arnica (Arnica Montana), rosemary (Rosmarinus officinalis N), marigold (Calendula officinalis), sage (Salvia officinalis N), ginseng (Panax Ginseng), St. Johns-wart (Hypericum Perforatum), ruscus (Ruscus aculeatus), meadowsweet (Filipendula ulmaria L) and orthosiphon (Ortosifon Stamincus Benth), as well as mixtures of these vegetable extracts.

The present fluids may comprise skin treating agents. Non-limiting examples of such skin actives include hydroxy acids such as salicylic acid; desquamatory agents such as zwitterionic surfactants; sunscreens such as 2-ethylhexyl-p-methoxycinnamate, 4,4′-t-butyl methoxydibenzoyl-methane, octocrylene, phenyl benzimidazole sulfonic acid; sun-blocks such as zinc oxide and titanium dioxide; anti-inflammatory agents; corticosteroids such as hydrocortisone, methylprednisolone, dexamethasone, triamcinolone acetconide, and desoxametasone; antipruitics such as camphor, menthol, oatmeal (colloidal), pramoxine, benzyl alcohol, phenol and resorcinol; hydroxy acids such as glycolic acid; keto acids such as pyruvic acid; N-acetyl-L-cysteine and derivatives thereof; benzofuran derivatives; and skin protectants. Mixtures of any of the above mentioned skin actives may also be used. Preferred skin actives include hydroxy acids such as salicylic acid, sunscreen, antioxidants and mixtures thereof.

The present fluids may also comprise a skin lightening agent, such as kojic acid, arbutin, ascorbic acid and derivatives thereof, e.g., magnesium ascorbyl phosphate. Further skin lightening agents suitable for use herein also include those described in WO95/34280 and WO 95/23780.

The present fluids may also comprise a skin colour enhancing agent, such as dihydroxyacetone. These compositions can also comprise a sugar molecule such as erythrulose.

Anaesthetics such as benzocaine, dyclonine, lidocaine and tetracaine may also be included within the present fluids.

The present fluids may additionally comprise an enzyme in an amount that is sufficiently effective to exfoliate the epidermis, e.g. facilitate the removal of dry skin flakes and/or to enhance the activity of skin active agents. Suitable enzymes for use herein include but are not limited to proteases and lipases (such as those lipases described in U.S. Pat. No. 6,284,246B1).

Proteases are classified under the Enzyme Classification number E.C. 3.4 (Carboxylic Ester Hydrolases) in accordance with the Recommendations (1992) of the International Union of Biochemistry and Molecular Biology (IUBMB). Proteases suitable for use herein are also described in PCT publications WO 95/30010, WO 95/30011, and WO 95/29979. Preferred proteases for use herein include, but are not limited to subtilisin, chymotrypsin and elastase protease enzymes and variants thereof, more preferably subtilisins, those proteases having homology to subtilisins (“subtilisin-like”) and variants of either. Subtilisin enzymes are naturally produced by Bacillus alcalophilus, Bacillus amyloliquefaciens, Bacillus amylosaccharicus, Bacillus licheniformis, Bacillus lentus and Bacillus subtilis microorganisms. The amino acid sequences of several subtilisins are known, and are set forth, for example, in WO 89/06279, published on 13 Jul. 1989 (Novo Nordisk). Suitable subtilisins for user herein include but are not limited to subtilisin BPN′, subtilisin Carlsberg, subtilisin DY, subtilisin 147, subtilisin 168, subtilisin 309, and subtilisin amylosaccaritus, preferably subtilisin BPN′. Also suitable are thermitase and aqualysin.

The present fluids may comprise a wide variety of emollients. Sagarin, Cosmetics, Science and Technology, 2nd Edition, Vol. 1, pp. 32-43 (1972) contains numerous examples of materials suitable as an emollient. Illustrative examples of emollients include:

i) Straight and branched chain hydrocarbons having from about 7 to about 40 carbon atoms, such as dodecane, squalane, cholesterol, hydrogenated polyisobutylene, isohexadecane and the C₇-C₄₀ isoparaffins, which are C₇-C₄₀ branched hydrocarbons.

ii) C₁-C₃₀ alcohol esters of C₁-C₃₀ carboxylic acids and of C₂-C₃₀ dicarboxylic acids, e.g. isononyl isononanoate, isopropyl myristate, myristyl propionate, isopropyl stearate, behenyl behenate, dioctyl maleate, diisopropyl adipate, and diisopropyl dilinoleate.

iii) mono-, di- and tri-glycerides of C₁-C₃₀ carboxylic acids and ethoxylated derivatives thereof, e.g., caprylic/capric triglyceride, PEG-6 caprylic/capric triglyceride.

iv) alkylene glycol esters of C₁-C₃₀ carboxylic acids, e.g. ethylene glycol mono- and di-esters, and propylene glycol mono- and di-esters of C₁-C₃₀ carboxylic acids e.g., ethylene glycol distearate.

v) C₁-C₃₀ mono- and poly-esters of sugars and related materials. These esters are derived from a sugar or polyol moiety and one or more carboxylic acid moieties. Depending on the constituent acid and sugar, these esters can be in either liquid or solid form at room temperature. Examples include: glucose tetraoleate, the galactose tetraesters of oleic acid, the sorbitol tetraoleate, sucrose tetraoleate, sucrose pentaoleate, sucrose hexaoleate, sucrose heptaoleate, sucrose octaoleate, sorbitol hexaester in which the carboxylic acid ester moieties are palmitoleate and arachidate in a 1:2 molar ratio, and the octaester of sucrose wherein the esterifying carboxylic acid moieties are laurate, linoleate and behenate in a 1:3:4 molar ratio. Other materials include cottonseed oil or soybean oil fatty acid esters of sucrose. Other examples of such materials are described in WO 96/16636. A particularly preferred material is known by the INCI name sucrose polycottonseedate

vi) Organopolysiloxane oils. The organopolysiloxane oil may be volatile, non-volatile, or a mixture of volatile and non-volatile silicones. The term “non-volatile” as used in this context refers to those silicones that are liquid under ambient conditions and have a flash point (under one atmospheric of pressure) of or greater than about 100° C. The term “volatile” as used in this context refers to all other silicone oils. Suitable organopolysiloxanes can be selected from a wide variety of silicones spanning a broad range of volatilities and viscosities. Non-volatile polysiloxanes are preferred. Suitable silicones are disclosed in U.S. Pat. No. 5,069,897. Preferred for use herein are organopolysiloxanes selected from the group consisting of polyalkylsiloxanes, alkyl substituted dimethicones, dimethiconols, poly-alkylaryl siloxanes, and mixtures thereof. More preferred for use herein are poly-alkylsiloxanes and cyclomethicones. Preferred among the polyalkylsiloxanes are dimethicones.

vii) Vegetable oils and hydrogenated vegetable oils. Examples of vegetable oils and hydro-genated vegetable oils include safflower oil, castor oil, coconut oil, cottonseed oil, menhaden oil, palm kernel oil, palm oil, peanut oil, soybean oil, rapeseed oil, linseed oil, rice bran oil, pine oil, sesame oil, sunflower seed oil, partially and fully hydrogenated oils from the foregoing sources, and mixtures thereof.

viii) animal fats and oils, e.g. cod liver oil, lanolin and derivatives thereof such as acetylated lanolin and isopropyl lanolate. Lanolin oil is preferred.

ix) Also useful are C₄-C₂₀ alkyl ethers of polypropylene glycols, C₁-C₂₀ carboxylic acid esters of polypropylene glycols, and di-C₈-C₃₀ alkyl ethers, examples of which include PPG-14 butyl ether, PPG-15 stearyl ether, dioctyl ether, dodecyl octyl ether, and mixtures thereof.

The present fluids may also comprise a humectant, particularly a polyhydric alcohol. Typical polyhydric alcohols include polyalkylene glycols and more preferably alkylene polyols and their derivatives, including propylene glycol, dipropylene glycol, polypropylene glycol, poly-ethylene glycol and derivatives thereof, sorbitol, hydroxypropyl sorbitol, erythritol, threitol, pentaerythritol, xylitol, glucitol, mannitol, hexylene glycol, butylene glycol (e.g., 1,3-butylene glycol), hexane triol (e.g., 1,2,6-hexanetriol), glycerine, ethoxylated glycerine and propoxylated glycerine.

Other humectants that may be employed include sodium 2-pyrrolidone-5-carboxylate, guanidine; glycolic acid and glycolate salts (e.g. ammonium and quaternary alkyl ammonium); lactic acid and lactate salts (e.g. ammonium and quaternary alkyl ammonium); aloe vera in any of its variety of forms (e.g., aloe vera gel); hyaluronic acid and derivatives thereof (e.g., salt derivatives such as sodium hyaluronate); lactamide monoethanolamine; acetamide mono-ethanolamine; urea; panthenol; sodium pyroglutamate (NaPCA), water-soluble glyceryl poly(meth)acrylate lubricants (such as Hispagel®) and mixtures thereof.

The present fluids may also comprise a high spreading oil comprising branched chain hydrocarbons having a weight average molecular weight of from about 100 to about 1000, such as isododecane, isohexadecane and isoeicosane. Preferred is isohexadecane.

Advantageously, these may be admixed with liquid ester emollients of formula I:

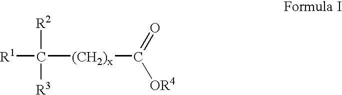

wherein R¹ is selected from H or CH₃, R², R³ and R⁴ are independently selected from C₁-C₂₀ straight chain or branched chain alkyl, and x is an integer of from 1 to 20. Suitable ester emollient materials of Formula I above include methyl isostearate, isopropyl isostearate, isostearyl neopentanoate, isononyl isononanoate, isodecyl octanoate, isodecyl isononanoate, tridecyl isononanoate, myristyl octanoate, octyl pelargonate, octyl isononanoate, myristyl myristate, myristyl neopentanoate, isostearyl neopentanoate, myristyl octanoate, myristyl propionate, isopropyl myristate and mixtures thereof.

A mixture of high spreading oils comprising isohexadecane and isopropyl isostearate is highly preferred.

The present fluids may also comprise an anti-tack agent selected from a poly(alphaolefin) having a MW of from about 260 to about 1000 and an occlusive agent selected from petrolatum, cetyl ricinoleate and lanolin.

The preferred occlusive anti-tack agent is petrolatum. Most preferred as an anti-tack agent is polydecene.

Present fluid compositions may comprise an organic particulate material having a refractive index of from about 1.3 to about 1.7, the particulate material being dispersed in the composition and having a volume average particle size in the range of from about 5 to about 30 μm, preferably from about 8 to about 15 μm. The organic particulates herein can also be useful in offsetting stickiness.

The volume average particle size is measured when the particulate material is in the neat form i.e. in the essentially pure, powder form prior to combination with the carrier of the invention. Particular methods of measuring particle size may, however, require the particulate material to be dispersed in an inert carrier, such as a pure oil, in order to measure the particle size distribution. Particle size can be determined by any suitable method known in the art, such as by using coulter-counter equipment or the ASTM Designation E20-85 “Standard Practice for Particle Size Analysis of Particulate Substances in the Range of 0.2 to 75 Micrometers by Optical Microscopy”, ASTM Volume 14.02, 1993.

Refractive index can be determined by conventional methods. For example, a method for determining the refractive index which is applicable to the present invention is described in J. A. Dean, Ed., Lange's Handbook of Chemistry, 14th Ed., McGraw Hill, N.Y., 1992, Section 9, Refractometry. The refractive index is preferably in the range from about 1.35 to about 1.6, this range closely matching the refractive index of skin.

Preferred particulates are free-flowing, porous, materials, especially those having spheroidal particles. Suitable organic particulate materials include those made of polymethyl-silsesquioxane, referenced above, polyamide, polythene, polyacrylonitrile, polyacrylic acid, poly-methacrylic acid, polystyrene, polytetrafluoroethylene (PTFE) and poly(vinylidene chloride). Copolymers derived from monomers of the aforementioned materials can also be used. Preferred are polyamides, especially nylon.

The present fluids may also comprise green, platelet-type interference pigment material having a TiO₂ layer thickness of from about 120 nm to about 160 nm or a whole number multiple thereof. Preferably, the interference pigment material comprises platelet type mica which is coated with TiO₂. The color of the reflected light varies depending on the thickness of the layer. The interference pigment material used in the present invention comprises at least a proportion of pigment material having a TiO₂ layer thickness of from about 120 nm to about 160 nm or a whole number multiple thereof such that the pigment itself has an overall green appearance when applied to skin as a result of light reflection from the pigment platelets. Without wishing to be bound by theory it is believed that the inclusion of a low level of a green interference pigment helps offset areas of redness in the skin, without itself imparting an unnatural green appearance. In this way it assists in providing an overall even skin tone. Suitable commercial examples are those supplied by Merck under the trade name Timiron®, especially Timiron® Silk Green, or supplied by Mearl under the trade name Flamenco®, especially Flamenco® Satin Green.

The present fluids may also comprise inorganic matting agents, such as titanium or zinc oxides, are also useful in the fluid compositions of the present invention. When present, the matting agent is used at a level of no more than 3% to avoid undesirable skin whitening or an unnaturally ‘opaque’ appearance. Preferred for use herein is titanium dioxide and especially anatase titanium dioxide.

Anatase titanium oxide has a density of about 3.90 g/cm³ and a tetragonal, cubic close packed structure. The refractive index of anatase titanium oxide is 2.55. Anatase titanium dioxide is available from Kobo Products Inc. under the trade name Kobo BTD 11S2, from Whittaker, Clark, Daniels, South Plainfield, N.J., USA, under the trade name TiO₂ 9729, and from Cardre Inc., South Plainfield, N.J., USA, under the trade name Carde 70429.

The present fluids may contain an emulsifier and/or surfactant, generally to help disperse and suspend the discontinuous phase within the continuous phase, in the case that the fluid is an emulsion. A surfactant may also be useful if the product is intended for skin cleansing. Known or conventional surfactants can be used in the composition, provided that the selected agent is chemically and physically compatible with essential components of the composition, and provides the desired characteristics. Suitable surfactants include non-ionic, anionic, amphoteric and zwitterionic surfactants such as those known in the art, for example from McCutcheon's, Detergents and Emulsifiers, North American Edition (1986), published by Allured Publishing Corporation.

Preferred emulsions of the present invention include a silicone containing emulsifier or surfactant. A wide variety of silicone emulsifiers are useful herein. These silicone emulsifiers are typically organically modified organopolysiloxanes, also known to those skilled in the art as silicone surfactants. Useful silicone emulsifiers include dimethicone copolyols. These materials are polydimethyl siloxanes which have been modified to include polyether side chains such as polyethylene oxide chains, polypropylene oxide chains, mixtures of these chains, and polyether chains containing moieties derived from both ethylene oxide and propylene oxide. Other examples include alkyl-modified dimethicone copolyols, i.e., compounds which contain C₂-C₃₀ pendant side chains. Still other useful dimethicone copolyols include materials having various cationic, anionic, amphoteric, and zwitterionic pendant moieties.

The present fluids may comprise a thickening agent selected from carboxylic acid polymers, crosslinked polyacrylates, polyacrylamides, xanthan gum and mixtures thereof, more preferably selected polyacrylamide polymers, xanthan gum and mixtures thereof. Preferred polyacrylamides are predispersed in a water-immiscible solvent such as mineral oil and the like, containing a surfactant (HLB from about 7 to about 10) which helps to facilitate water dispersibility of the polyacrylamide. Most preferred for use herein is the non-ionic polymer under the CTFA designation: polyacrylamide and isoparaffin and laureth-7, available under the trade name Sepigel 305 from Seppic Corporation.

Other suitable thickeners include cellulose and derivatives, acacia, agar, algin, alginic acid, ammonium alginate, amylopectin, calcium alginate, calcium carrageenan, carnitine, carrageenan, dextrin, gelatin, gellan gum, guar gum, guar hydroxypropyltrimonium chloride, hectorite, hyaluroinic acid, hydrated silica, hydroxypropyl chitosan, hydroxypropyl guar, karaya gum, kelp, locust bean gum, natto gum, potassium alginate, potassium carrageenan, propylene glycol alginate, sclerotium gum, sodium carboxymethyl dextran, sodium carrageenan, tragacanth gum, xanthan gum, and mixtures thereof. Also useful are acrylic acid/ethyl acrylate copolymers and the carboxyvinyl polymers sold by the B.F. Goodrich Company under the trademark of Carbopol resins. Suitable Carbopol resins are described in WO98/22085.

The present fluids may comprise an anti-oxidant/radical scavenger, which may provide protection against UV radiation which can cause increased scaling or texture changes in the stratum corneum and against other environmental agents which can cause skin damage.

Anti-oxidants/radical scavengers such as ascorbic acid (vitamin C) and its salts, ascorbyl esters of fatty acids, ascorbic acid derivatives (e.g., magnesium ascorbyl phosphate), β-carotene, tocopherol (vitamin E), tocopherol sorbate, tocopherol acetate, other esters of tocopherol, butylated hydroxy benzoic acids and their salts, gallic acid and its alkyl esters, especially propyl gallate, uric acid and its salts and alkyl esters, sorbic acid and its salts, amines (e.g., N,N-diethylhydroxylamine, amino-guanidine), sulflhydryl compounds (e.g., glutathione), dihydroxy fumaric acid and its salts, bioflavonoids, lysine, methionine, proline, superoxide dismutase, silymarin, tea extracts, grape skin/seed extracts, melanin, and rosemary extracts may be used. Preferred anti-oxidants/radical scavengers are selected from tocopherol acetate, tocopherol sorbate and other esters of tocopherol, more preferably tocopherol acetate.

The present fluids may also comprise a chelating agent is especially useful for providing protection against UV radiation which can contribute to excessive scaling or skin texture changes and against other environmental agents which can cause skin damage. Exemplary chelators that are useful herein are disclosed in U.S. Pat. No. 5,487,884. Preferred chelators useful in compositions of the subject invention are ethylenediamine tetraacetic acid (EDTA), furildioxime and derivatives thereof.

Desquamation agents may also be added to the present fluids to enhance the skin appearance. A variety of desquamation agents are known in the art and are suitable for use herein, including organic hydroxy acids such as salicylic acid, glycolic acid, lactic acid, 5-octanoyl salicylic acid, hydroxyoctanoic acid, hydroxycaprylic acid, and lanolin fatty acids. Salicylic acid is preferred.

The present fluids may also comprise pigments and other particulates which may provide visual benefits. Pigments suitable for use in the compositions of the present invention can be organic and/or inorganic. Also included within the term pigment are materials having a low colour or lustre such as matte finishing agents, and also light scattering agents. Examples of suitable pigments are iron oxides, acylglutamate iron oxides, titanium dioxide, ultramarine blue, D&C dyes, carmine, and mixtures thereof. Depending upon the type of composition, a mixture of pigments will normally be used. Other particulates useful herein include Orgasol®, Nylon Poly®, Dry-Flo Plus®, polymethylsilsesquioxane and dimethicone/vinyl dimethicone cross polymer.

The present fluids may also comprise a crosslinked organopolysiloxane elastomer. The crosslinked organopolysiloxane elastomers can be either partially or completely crosslinked, and can be selected from the group comprising of emulsifying and non-emulsifying elastomers. Emulsifying elastomers are essential for water in silicone elastomeric formulations. Preferred crosslinked organopolysiloxane elastomers are selected from dimethicone/vinyl dimethicone copolymers and organopolysiloxanes containing a polyoxyethylenated and/or polyoxypropylenated chain. Dimethicone/vinyl dimethicone copolymers are supplied by a variety of suppliers including Dow Corning (DC 9040 and DC 9041), General Electric (SFE 839), Shin Etsu (KSG-15, 16, 18 [dimethicone/phenyl vinyl dimethicone crosspolymer]), and Grant Industries (Gransil™ line of materials), and lauryl dimethicone/vinyl dimethicone crosspolymers supplied by Shin Etsu (e.g., KSG-31, KSG-32, KSG-41, KSG-42, KSG-43, and KSG-44). Organopolysiloxanes containing a polyoxyethylenated and/or polyoxypropylenated chain are marketed by Shin-Etsu under the name KSG21, KSG31, KSG31x and KSG32 or by Dow Corning under the name DC 9011.

The cosmetically or pharmaceutically acceptable vehicle comprised within the present fluids should also be physically and chemically compatible with the essential components described herein, and should not unduly impair stability, efficacy or other use benefits associated with the compositions of the present invention.

Preferred vehicles contain a dermatologically acceptable, hydrophilic diluent. Suitable hydrophilic diluents include water, organic hydrophilic diluents such as C₁-C₄ monohydric alcohols and low molecular weight glycols and polyols, including propylene glycol, polyethylene glycol (e.g. of MW 200-600), polypropylene glycol (e.g. of MW 425-2025), glycerol, butylene glycol, 1,2,4-butanetriol, sorbitol esters, 1,2,6-hexanetriol, ethanol, iso-propanol, sorbitol esters, ethoxylated ethers, propoxylated ethers and combinations thereof. The diluent is preferably liquid. Water is an especially preferred diluent.

Preferred vehicles are emulsions comprising a hydrophilic phase, especially an aqueous phase, and a hydrophobic phase e.g., a lipid, oil or oily material. As well known to one skilled in the art, the hydrophilic phase will be dispersed in the hydrophobic phase, or vice versa, to form respectively hydrophilic or hydrophobic dispersed and continuous phases, depending on the composition ingredients. The emulsion may also comprise a gel network, such as described in G. M. Eccleston, Application of Emulsion Stability Theories to Mobile and Semisolid O/W Emulsions, Cosmetics & Toiletries, Vol. 101, November 1996, pp. 73-92. Preferred compositions herein are oil-in-water emulsions.

Preferred compositions have an apparent viscosity of from about 5,000 to about 200,000 mPa.s (centipoise). Apparent viscosity can be determined using a Brookfield DVII RV viscometer, spindle TD, at 5 rpm, or the equivalent thereof. The viscosity is determined on the composition after the composition has been allowed to stabilize following its preparation, generally at least 24 hours under conditions of 25° C.+/−1° C. and ambient pressure after preparation of the composition. Apparent viscosity is measured with the composition at a temperature of 25° C.+/−1° C., after 30 seconds spindle rotation.

The compositions of the present invention are usually formulated to have a pH of 9.5 or below and in general have a pH in the range from about 4.5 to about 9, more preferably from about 5 to about 8.5. Some compositions, particularly those comprising an additional active such as salicylic acid, require a lower pH in order for the additional active to be fully efficacious. These compositions are usually formulated to have a pH of from about 2.5 to about 5, more preferably from about 2.7 to about 4.

The fluid compositions of the present invention are generally prepared by conventional methods such as are known in the art of making topical compositions. Such methods typically involve mixing of the ingredients in one or more steps to a relatively uniform state, with or without heating, cooling, application of vacuum, and the like.

Water Flux Rate Test

The Water Flux Rate Test, referred to above, measures the water permeability of a substrate.

In order to measure the Water Flux Rate, with tape or rubber bands, affix a substrate to the bottom of a plastic funnel with the following measurements: a 24 mm inner diameter (i.d.) at the exit, a 145 mm i.d. at the top, 135 mm height, a 20 mm length neck, and a total volume of about 600 ml. Apply sufficient tension to the substrate to ensure that the substrate is completely flat, and no more. Affix tape and rubber bands as close as possible to the exit of the funnel to keep backflow from occurring under water pressure.

Next, place the throttled funnel in a ringstand over a sink. Measure out 600 ml of water at room temperature in a graduated cylinder. Then, with one hand blocking the funnel exit, pushing against the test substrate, quickly pour the water into the funnel. Once the funnel is completely filled, remove the hand and measure the drainage time for the water to evacuate the funnel to the nearest tenth of a second. Stop timing when the water reaches the junction of the neck and the sloped portion of the funnel. Repeat this process 5 times per test substrate and average the measurements for each substrate. Substrates which exhibit long drainage times (>10 minutes) can be tested by weighing the water drained in a set time period, e.g., 5 minutes, with a funnel full of water. Then remove the substrate from the funnel and reverse the substrate to the other side and reattach to funnel's exit. Measure the water flux rate in the opposite direction (unless the substrate is the same in both directions), and the average the results. The Water Flux Rate is expressed in cm³/cm²-s according to the following equation:

Water Flux Rate=(600 grams water)×(1 cm³ per gram)/{π×(1.2 cm)²×(average time in seconds)}.

Fluid Formula Examples

| | Formula | Formula | Formula | Formula | Formula | Formula |
|---|---|---|---|---|---|---|
| Raw Material | 1 | 2 | 3 | 4 | 5 | 6 |
| Deionized | To 100 | To 100 | To 100 | To 100 | To 100 | To 100 |
| Water | | | | | | |
| Sepigel 305 | 2.2 | 2.2 | 2.3 | 3.3 | 3.0 | 1.5 |
| (Polyarylamide | | | | | | |
| & C13-14 | | | | | | |
| Isoparaffin | | | | | | |
| & Laureth-7) | | | | | | |
| Emulgade | 0.20 | 0.20 | 0.25 | 0.25 | 0.40 | 0.20 |
| PL68/50 | | | | | | |
| (Cetearyl | | | | | | |
| Glucoside & | | | | | | |
| Cetearyl | | | | | | |
| Alcohol) | | | | | | |
| Steareth 2 | — | — | — | 0.05 | 0.1 | — |
| Steareth 21 | — | — | — | 0.45 | 0.90 | — |
| Stearic Acid | 0.10 | 0.10 | — | — | 0.10 | 0.10 |
| PEG 100 | 0.10 | 0.10 | 0.10 | 0.10 | 0.10 | 0.10 |
| Stearate | | | | | | |
| Stearyl Alcohol | 0.65 | 0.65 | 0.70 | 0.45 | 0.30 | 0.61 |
| Cetyl Alcohol | 0.40 | 0.40 | 0.52 | 1.75 | 1.50 | 0.42 |
| Behenyl | 0.40 | 0.40 | 0.40 | 1.25 | 1.20 | 0.45 |
| Alcohol | | | | | | |
| Petrolatum | 1.0 | 1.0 | 2.0 | — | 2.0 | 2.0 |
| DC Q2 1403 | 2.0 | 2.0 | 2.0 | 2.0 | 2.0 | 1.0 |
| (Dimethicone | | | | | | |
| & | | | | | | |
| Dimethiconol) | | | | | | |
| Isohexadecane | 5.0 | 5.0 | 5.40 | — | 1.0 | 3.0 |
| Isopropyl | 2.40 | 2.40 | 2.50 | — | 1.0 | 1.5 |
| Isostearate | | | | | | |
| Isopropyl | — | — | — | 2.00 | — | — |
| Palmitate | | | | | | |
| Sefa Cottonate | 1.20 | 1.20 | 1.20 | — | 1.20 | — |
| Cocoa Butter | — | Max 1 | 4.00 | — | — | — |
| Coconut Oil | — | Max 1 | 4.00 | — | — | — |
| Olive Squalane | — | Max 1 | — | — | 2.0 | — |
| White Beeswax | — | — | — | — | 6.0 | — |
| Nylon 12 | 2.0 | 2.0 | 1.5 | — | 2.0 | 1.0 |
| Dry Flo Plus | — | — | — | — | — | 2.0 |
| (Aluminium | | | | | | |
| Starch | | | | | | |
| Octenyl- | | | | | | |
| succinate) | | | | | | |
| Tospearl 145A | 0.25 | 0.25 | 0.25 | 1.00 | — | — |
| (Polymethyl- | | | | | | |
| silsesquioxane) | | | | | | |
| Timeron Super | — | — | — | 0.25 | — | — |
| Green | | | | | | |
| Glycerin | 10.0 | Max 25 | 10.0 | 7.0 | 10.0 | 10.0 |
| Tocopheryl | 0.50 | 0.50 | 1.0 | 0.50 | 0.50 | 0.25 |
| Acetate | | | | | | |
| Niacinamide | 3.50 | 5 | — | 2.00 | — | 3.50 |
| Panthenol | 0.50 | 0.50 | 0.50 | 0.50 | 0.50 | 0.50 |
| Sodium | 0.011 | 0.011 | — | — | 0.011 | 0.011 |
| Hydroxide | | | | | | |
| Salicylic Acid | — | — | — | — | 2 | — |
| Triethanol- | — | — | — | 0.70 | — | — |
| amine (TEA) | | | | | | |
| Citric Acid | — | — | 0.22 | — | — | — |
| DHA | — | — | 5.00 | — | — | — |
| (Dehydroacetic | | | | | | |
| Acid) | | | | | | |
| Erythrulose | — | — | 2.00 | — | — | — |
| Octyl | — | — | — | 4.50 | — | — |
| Salicylate | | | | | | |
| Avobenzone | — | — | — | 2.00 | — | — |
| PBSA | — | — | — | 1.25 | — | — |
| Octocrylene | — | — | — | 1.50 | — | — |
| Benzyl Alcohol | 0.25 | 0.25 | 0.25 | 0.25 | — | 0.25 |
| Ethyl Paraben | 0.15 | 0.15 | 0.15 | 0.10 | 0.15 | 0.15 |
| Propyl Paraben | 0.07 | 0.07 | 0.07 | 0.10 | 0.07 | 0.07 |
| Methyl Paraben | — | — | — | 0.20 | — | — |
| Disodium | 0.10 | 0.10 | 0.10 | 0.10 | 0.10 | 0.10 |
| EDTA | | | | | | |
| Perfume | 0.175 | 0.175 | 0.175 | 0.15 | 0.175 | 0.175 |

### EXAMPLE 1

This example comprises a Flow Control Layer comprising a CLIFF™ (Cloth Like Formed Film) hydroapertured film supplied by Tredegar Corp. of LDPE with 1% ATMER™ (Uniquema) and 0.8 gsm silicone coating having a water flux rate through the material of 60 cm²/cm³-s; this layer is superposed onto a Fluid Storage Layer comprising 80 gsm polyester/polyethylene terephthalate batting available from Vliessstoffwerk Sandier GmbH & Co. KG, which itself is superposed onto a fluid impermeable LDPE film layer of 0.2 mm thickness. All layers are circular and have a diameter of 10 cm.

The applicator is assembled by placing the Fluid Storage Layer on the fluid impermeable film layer. 3 ml of lotion as defined in Formula 1, above, is impregnated into the fluid storage layer and the flow control layer is placed on top of the fluid storage layer. The substrates are bonded around their periphery by ultra-sonic sealing.

### EXAMPLE 2

This example comprises a Skin Contact Layer comprising a LLDPE 60 gsm spun bonded from Corovin with a film thickness of 0.5 mm, superposed onto a Flow Control Layer comprising a CLIFF™ (Cloth Like Formed Film) hydroapertured film of LDPE with 1% ATMER (Uniqema) and 0.8 gsm silicone coating having a water flux rate through the material of 100 cm²/cm³-s, superposed onto a Fluid Storage Layer comprising 200 gsm needle punched viscose supplied by Texel, Canada, which itself is superposed onto a fluid impermeable LDPE film layer supplied by ACE SA (Belgium), with a film thickness of 0.2 mm. The fluid impermeable layer is superposed onto a skin contact layer comprising 50:50 rayon:polyproylene hydroentangled from Fibrella (supply code 310062). All layers are square shaped with rounded edges and have a diameter of 8 cm.

The applicator is assembled by placing the liquid impermeable film on the hand contact layer. The fluid storage layer is then placed on the liquid impermeable film and 10 ml of lotion as defined in Formula 2 is impregnated into the fluid storage layer and the flow control layer and skin contact layers are placed on top of the fluid storage layer. The substrates are bonded around the periphery and in the centre by ultra sonic sealing.

What is claimed is:

1. A disposable fluid applicator, said applicator comprising; a substrate and a fluid, the substrate comprising, in succession:
a) a flow control layer;
b) a fluid storage layer; and
c) a fluid impermeable layer
wherein at least about 0.5 milliliters of said fluid are present in said fluid storage layer.

2. The disposable applicator of claim 1, wherein from about 10 milliliters to about 20 milliliters of said fluid are present in said fluid storage layer.

3. The disposable applicator of claim 1, wherein from about 12 milliliters to about 15 milliliters of said fluid are present in said fluid storage layer.

4. The disposable applicator of claim 1, wherein said fluid is selected from the group consisting of liquids, gels, lotions, creams and powders.

5. The disposable applicator of claim 1, wherein said fluid comprises an active agent that is selected from the group consisting of vitamin compounds, skin treating agents, cleansing surfactants, anti-acne actives, anti-wrinkle actives, anti-skin atrophy actives, anti-inflammatory actives, topical anesthetics, coloring agents, artificial tanning actives and accelerators, anti-microbial actives, anti-fungal actives, anti-viral agents, enzymes, sunscreen actives, anti-oxidants, skin exfoliating agents, and combinations thereof.

6. The disposable applicator of claim 1, wherein the flow control layer is selected from the group consisting of an apertured film, non-woven material, non-woven with microfibers, woven material, meltblown structure and mixtures thereof.

7. The disposable applicator of claim 6, wherein the flow control layer comprises CLIFF film.

8. The disposable applicator of claim 1, wherein the fluid storage layer is selected from the group consisting of batting, sponge, foam and combinations thereof.

9. The disposable applicator of claim 8, wherein the batting comprises viscose fibers.

10. The disposable applicator of claim 1, wherein the fluid storage layer comprises a dosing reservoir capable of containing and dispensing fluid.

11. The disposable applicator of claim 10, wherein the dosing reservoir is rupturable.

12. The disposable applicator of claim 1, wherein the fluid impermeable layer is selected from the group consisting of a polymer film, a metal foil, a laminate polymer film, a laminate metal foil and mixtures thereof.

13. The disposable applicator of claim 1, further comprising a skin contact layer located on the opposite side of the flow control layer to the fluid storage layer.

14. The disposable applicator of claim 13, wherein the skin contact layer material is selected from the group consisting of woven materials, non-woven materials, natural or synethic sponge, polymeric mesh sponge, paper substrate, polymeric porous foam, collagen sheets, polymeric scrim and mixtures thereof.

15. The disposable applicator of claim 1, further comprising a hand contact layer located on the opposite side of the fluid impermeable layer to the fluid storage layer.

16. The disposable applicator of claim 15, wherein the hand contact layer material is selected from the group consisting of woven materials, non-woven materials, natural or synethic sponge, polymeric mesh sponge, paper substrate, polymeric porous foam, collagen sheets, polymeric scrim and mixtures thereof.

17. The disposable applicator of claim 1, additionally comprising a temperature-change element for heating or cooling the substrate, the fluid or both.

18. The disposable applicator of claim 17, wherein the temperature-change element provides heat selected from the group consisting of chemical reaction, heat of solution, crystallization and mixtures thereof.

19. The disposable applicator of claim 17, wherein the temperature-change element is a cooling element; wherein cooling is provided by an endothermic chemical reaction.

20. The disposable applicator of claim 17, additionally defining a catalyst chamber containing a catalyst and a separate reactant chamber containing a reactant wherein said reactant chamber and catalyst chamber are rupturable so that on rupture their respective contents mix to initiate the reaction and generate the temperature change.

21. A method of applying a fluid to skin comprising;
1) holding the disposable applicator said applicator comprising a substrate and a fluid, the substrate comprising, in succession:
a) a flow control layer;
b) a fluid storage layer; and
c) a fluid impermeable layer
wherein at least about 0.5 milliliters of said fluid are present in said fluid storage layer; and
2) wiping it onto the skin.
